(19) United States
(12) Patent Application Publication
(10) Pub. No.: US 2011/0206247 A1
(43) Pub. Date: Aug. 25, 2011

(54) Imaging system and methods for cardiac analysis

(76) Inventors: Frank C. Dachille, Amityville, NY (US); Kevin Kreeger, Sunnyvale, CA (US); Jenny Hizver, Centereach, NY (US); Wenli Cai, Middle Island, NY (US); George Economos, Bayport, NY (US)

(21) Appl. No.: 10/496,438

(22) PCT Filed: Nov. 21, 2002
(86) PCT No.: PCT/US02/37398

§ 371 Date: Feb. 13, 2007

Related U.S. Application Data
(60) Provisional application No. 60/331,799, filed on Nov. 21, 2001.
(60) Provisional application No. 60/331,779, filed on Nov. 21, 2001.

(51) Int. Cl. G06K 9/00

(52) U.S. Cl. 382/128

(57) ABSTRACT

Imaging systems and methods for viewing medical images of human anatomy and, in particular, to a 3-dimensional imaging system that allows a user to efficiently and accurately detect and view coronary artery calcification as displayed graphically on a computer screen. In one aspect, a method for displaying medical images comprises obtaining an image dataset comprising anatomical image data (step 50), automatically grouping connected components in the image data to form groups of connected components (steps 50-57), and displaying the groups of connected components are distinguishable in the displayed image (58-59). The image dataset may comprise a volume data set and the groups of connected components comprise regions of neighboring voxels that share a similar property. The image dataset may comprise a 2-dimensional data set and the groups of connected components comprise regions of neighboring pixels that share a similar property. Different groups of connected components may be displayed in different colors and/or different opacities or certain groups may not be displayed at all.

### CROSS-REFERENCE TO RELATED APPLICATIONS

This application claims priority to U.S. Provisional Application Nos. 60/331,799 and, 60/331,779, both of which were filed on Nov. 21, 2001, and both of which are fully incorporated herein by reference.

### TECHNICAL FIELD OF THE INVENTION

The present invention relates generally to imaging systems and methods for viewing medical images of human anatomy. More specifically, the invention relates to a 3-dimensional imaging system that allows a user to efficiently and accurately detect and view coronary artery calcification as displayed graphically on a computer screen.

### BACKGROUND

Various systems and methods have been developed to enable two-dimensional (2D) visualization of human organs, such as the heart, by radiologists and physicians for diagnosis and formulation of treatment strategies. Such systems and methods include CT (Computed Tomography) such as EBCT (Electron-Beam Computed Tomography) and MSCT (Multi-Slice Computed Tomography).

Radiologists and other specialists have historically been trained to analyze CT scan data consisting of two-dimensional slices. These views are sometimes referred to as “slices” of the actual three-dimensional volume. Experienced radiologists and similarly trained personnel can often mentally correlate a series of 2D images derived from these data slices to obtain useful three-dimensional (3D) information. However, while stacks of such slices may be useful for analysis, they do not provide an efficient or intuitive means to analyze complex organs such as the heart, or other organs as tortuous and complex as the colon or arteries. Indeed, there are many applications in which depth or 3D information is useful for diagnosis and formulation of treatment strategies. For example, when imaging blood vessels, cross-sections merely show slices through vessels, making it difficult to diagnose stenosis or other abnormalities.

According to the Mayo Clinic, cardiovascular disease, more commonly called Coronary Artery Disease (CAD), is the most common form of heart disease. FIG. 1 is a diagram of a human heart illustrating the major coronary arteries. These arteries include the Left Main Artery (LMA), the Left Anterior Descending (LAD), the Left Circumflex Artery (LC), the Right Coronary Artery (RCA), and the Posterior Descending Artery (PD).

Arteriosclerosis is a general medical term that refers to several chronic coronary diseases, and is generally used to describe the gradual hardening of arterial walls. The most common and familiar form of arteriosclerosis is atherosclerosis where fatty calcium deposits are formed in coronary arteries. Calcification begins when calcium phosphate deposits (containing 40% calcium by weight) attach to cholesterol deposits on the walls of diseased coronary arteries. Calcification may also occur around one or more of the four valves of the heart, causing narrowing of the valve, which leads to conditions such as calcified aortic valve stenosis. The more extensive the calcification, the more frequent and more severe the degree of stenosis. These calcium deposits can gradually narrow the walls of the arteries, and can also harden the areas where arterial walls are inflamed. Calcified plaque is classified as “hard plaque,” which originates from a build up of calcified plaque over time. Physicians use the amount of calcified plaque as an indicator for detecting the presence and degree of atherosclerosis.

Various non-invasive imaging systems have been developed for aiding in determining (scoring) the amount of calcium in coronary arteries. Calcium on arterial surfaces displays a comparatively high X-ray density, approximately two to 10 times greater than the surrounding soft tissue. CT densities are defined in Hounsfield Units (HU), named after the Nobel Prize winner who developed X-ray computed tomography. Hounsfield Units range from −1000 (air) to zero (water), and to over +1000 (compact bone).

Agatston scoring is one conventional method that is used to establish the quantification of coronary calcium with EBCT. Coronary calcium has a “threshold” of 130 HU in at least three contiguous pixels through the volume of the tomogram. The Agatston calcium score is determined as the area of calcification per coronary tomographic segment that is multiplied by a factor rated 1 through 4, dictated by the maximum calcium X-ray density within that segment (attenuation coefficient). The multiplication factor for a given calcium lesion is “1” if the density is between 131 and 199; “2” if the density is 200 to 299; “3” if the density is 300 to 399; and “4” if the density is >400. A calcium score can be calculated for a given coronary segment, a specific coronary artery, or for the entire coronary system.

The Volume Score is another method for quantifying coronary calcium, which score is determined to be the volume of calcium, in cubic millimeters, in all the voxels belonging to the same plaque deposit. For each lesion, the number of voxels containing calcium is summed to obtain a total volume for each artery location, and the volume is calculated as the product of the number of voxels containing calcium and the volume of one voxel.

Unfortunately, coronary calcification is not easily detected and measurable with conventional chest radiographs and other conventional systems and methods. Indeed, typical heart visualizations can be obscured from the spine and ribs enclosing the chest cavity, for example. Accordingly, there is a need for an improved imaging system and method intuitive and reliable system and method for detecting and measuring coronary calcification in coronary arteries. Indeed, systems that could enable a physician can accurately detect, measure and accurately report on calcium deposit sites in the human heart arteries are desirable so appropriate action can be taken to save lives, reduce risk, and lessen health-care costs.

### SUMMARY OF THE INVENTION

The present invention relates to imaging systems and methods for viewing medical to images of human anatomy and, in particular, to a 3-dimensional imaging system that allows a user to efficiently and accurately detect and view coronary artery calcification as displayed graphically on a computer screen. Systems and methods are provided that help make the scoring of coronary plaques less problematic. For example, a method according to one aspect of the invention provides automated differentiation of noise and bones based on user-specified volume thresholds to reduce visual clutter and allow a less tedious method of selecting lesions (plaques). In another aspect, a method is provided for using an integrated 3D shaded surface display with overlaid plaques, which more clearly shows the distribution of plaques, for better visualization.

More specifically, in one aspect of the invention, a method for displaying medical images comprises obtaining an image dataset comprising anatomical image data, automatically grouping connected components in the image data to form groups of connected components, and displaying an image such that the groups of connected components are distinguishable in the displayed image. The image dataset may comprise a volume data set and the groups of connected components comprise regions of neighboring voxels that share a similar property. The image dataset may comprise a 2-dimensional data set and the groups of connected components comprise regions of neighboring pixels that share a similar property. Different groups of connected components may be displayed in different colors and/or different opacities or certain groups may not be displayed at all.

In another aspect of the invention, a method for displaying medical images comprises obtaining an image dataset comprising anatomical image data, volume rendering the image data, rendering a subset of the image data, and displaying an image of the volume rendered image data and rendered subset such that a view of the data in the subset is not obscured by remaining image data in the view.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating coronary arteries of a human heart.

FIG. 2 is a diagram of a 3D imaging system according to an embodiment of the invention.

FIG. 3 is a flow diagram illustrating a method for processing image data according to an embodiment of the invention.

FIG. 4 is a flow diagram illustrating a method for processing image data according to an embodiment of the invention.

FIG. 5 is a flow diagram illustrating a method for providing automatic separation of noise, bone and potential plaques based on user-preference data, according to one aspect of the invention.

FIG. 6 is a diagram of a user interface according to one embodiment of the invention.

FIG. 7 is a diagram of a user interface according to another embodiment of the invention.

FIGS. 8(a)-(d) are graphic diagrams of user interfaces for setting user-preference data according to an embodiment of the invention.

FIGS. 9(a)-(d) are diagrams illustrating methods for region growing, which may be used for providing automatic separation of noise, bone and potential plaques based on user-preference data, according to one aspect of the invention.

FIG. 10 is a 3D image illustrating a method for superimposing plaque sites on top of an image, according to one aspect of the invention.

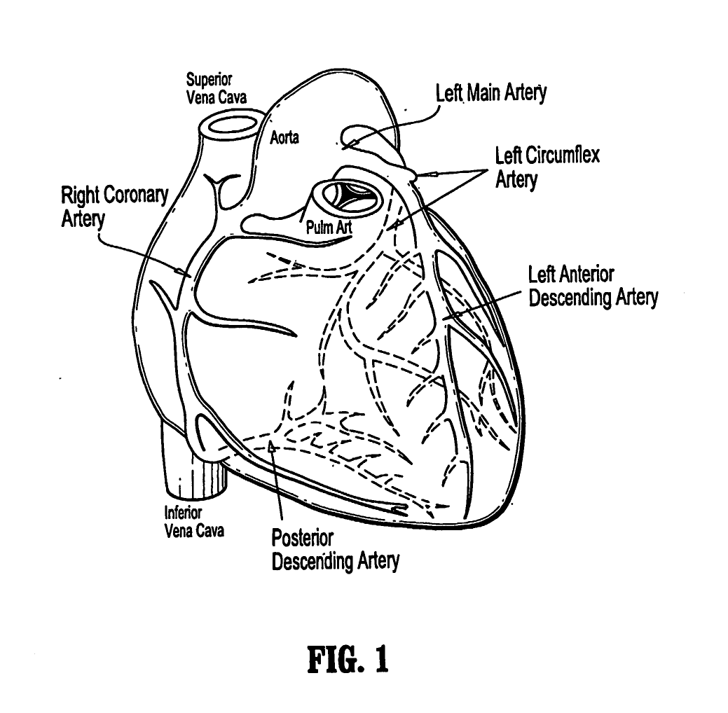

### DETAILED DESCRIPTION OF PREFERRED EMBODIMENTS

The present invention is generally directed to imaging systems and methods for viewing medical images of human anatomy. Preferred embodiments of the invention are directed to 3D imaging systems comprising a calcium scoring tool that can be used by physicians for cardiac analysis and determining the amount of calcium plaque accumulation in coronary arteries, although one of ordinary skill in the art can readily envision application of the invention for diagnosing other anatomical components. A calcium scoring application according to the invention is preferably designed to receive a 2D image dataset from an Electron-Beam Computed Tomography (EBCT) or Multi-Slice Computed Tomography (MSCT) and transform the dataset into a 3D, density-filled electronic model of the patient's heart, which is displayed on a PC screen. In general, a calcium scoring application according to the invention enables physicians to (i) conduct a safe and effective calcium scoring examination of the electronic model of a patient's heart and coronary arteries for cardiac analysis, (ii) navigate the reconstructed electronic 3D image of the heart and select and assign plaque sites to coronary arteries and to (iii) generate diagnostic and follow-up reports on the calcium scoring examination.

It is to be understood that the systems and methods described herein in accordance with the present invention may be implemented in various forms of hardware, software, firmware, special purpose processors, or a combination thereof. Preferably, the present invention is implemented in software as an application comprising program instructions that are tangibly embodied on one or more program storage devices (e.g., magnetic floppy disk, RAM, CD Rom, ROM and flash memory), and executable by any device or machine comprising suitable architecture.

It is to be further understood that since the constituent system modules and method steps depicted in the accompanying Figures are preferably implemented in software, the actual connection between the system components (or the flow of the process steps) may differ depending upon the manner in which the present invention is programmed. Given the teachings herein, one of ordinary skill in the related art will be able to contemplate these and similar implementations or configurations of the present invention.

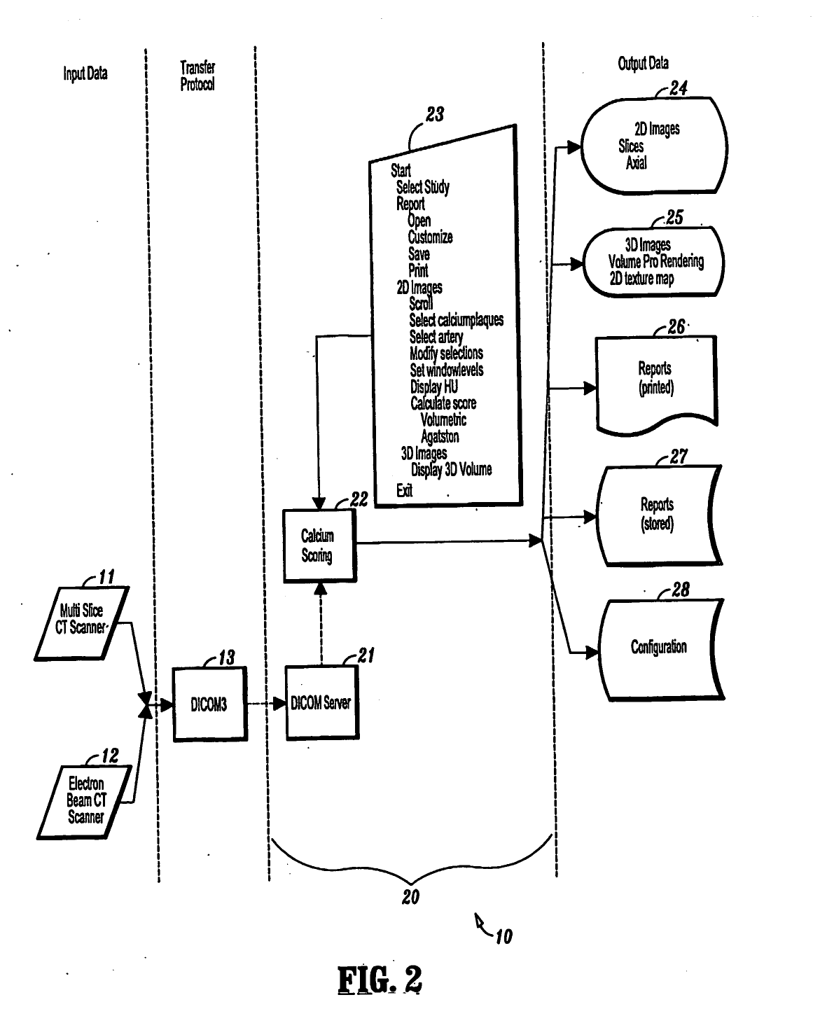

FIG. 2 is a diagram of a three-dimensional (3D) imaging system according to an embodiment of the invention for aiding in cardiac analysis. The system (10) receives input data comprising one or more of a plurality of 2D image datasets (11, 12) generated by CT medical image acquisition devices. The 2D datasets (11, 12) are DICOM formatted via DICOM module (13). By way of example, the 2D image datasets comprise a MSCT (Multi-Slice Computed Tomography) dataset (11) or an EBCT dataset (12). It is to be understood that the system (10) can be used to interpret any DICOM formatted dataset.

The system (10) further comprises a calcium scoring system (20) which provides a tool for a physician to analyze the DICOM-formatted CT dataset scans of a human heart and measure the amount of calcium plaque accumulation within the coronary arteries. The calcium scoring system (20) provides the physician with a “calcium score” (an amalgamation of the total size and density of calcific deposits throughout the coronary arteries) and provides a report that relates the calcium score to the patient's risk of coronary artery disease. In general, the calcium scoring system (20) comprises a DICOM server (21), a calcium scoring module (22) and a library (23) comprising a plurality of functional modules (classes) that are accessed by the calcium scoring module (22) for performing various functions as described in detail below.

The DICOM server provides an interface to DICOM systems and to receive and process the DICOM-formatted datasets received from the various medical image scanners. The server (21) may comprise software for converting the 2D DICOM-formatted datasets to a volume dataset. The DICOM server (21) can be configured to, e.g., continuously monitor a hospital network and seamlessly accept patient studies automatically into the system (20) database the moment such studies are “pushed” from an imaging device.

The calcium scoring module (22) performs functions such as rendering and displaying interactive 2D and 3D views from diagnostic CT images and obtaining measurements with respect to calcium deposits in the coronary arteries, interpolate the original volume dataset to enhance the ability of detection of small plaques. In addition, the calcium scoring module (22) provides meta-data storage for reference and follow-up evaluation of patient status over time and allows a user to generate reports specific to the patient with calcium score measurements. Such reports include diagnostic reports, which provide data related to the actual status of the coronary calcium, and follow-up reports, which provide evaluation information collected over time and the actual status of the coronary calcium.

The calcium scoring module (22) provides various UIs (user interfaces) (e.g., Graphic User Interfaces) that enable a user to access the various functions of the calcium scoring system (20). For instance, the calcium scoring module (22) enables a user to select, open and store patient studies in a database. The calcium scoring module (22) provides a GUI for the user to produce a novel, rotatable 3D model of an anatomical area of interest from an internal or external vantage point. The GUIs provide access points to menus, buttons, slider bars, checkboxes, views of the 3D electronic model and 2D patient slices of the patient study. The user interface is interactive and preferably mouse driven, although keyboard shortcuts are available to the user to issue computer commands.

The output of the calcium scoring system (20) comprises a graphical output of 2D images (24) and 3D images, which are presented to the user to asses the anatomy of the cardiac areas, printed (or faxed) reports (26) or report files (27) that are stored in a database, and configuration data (61) that can be stored in the database.

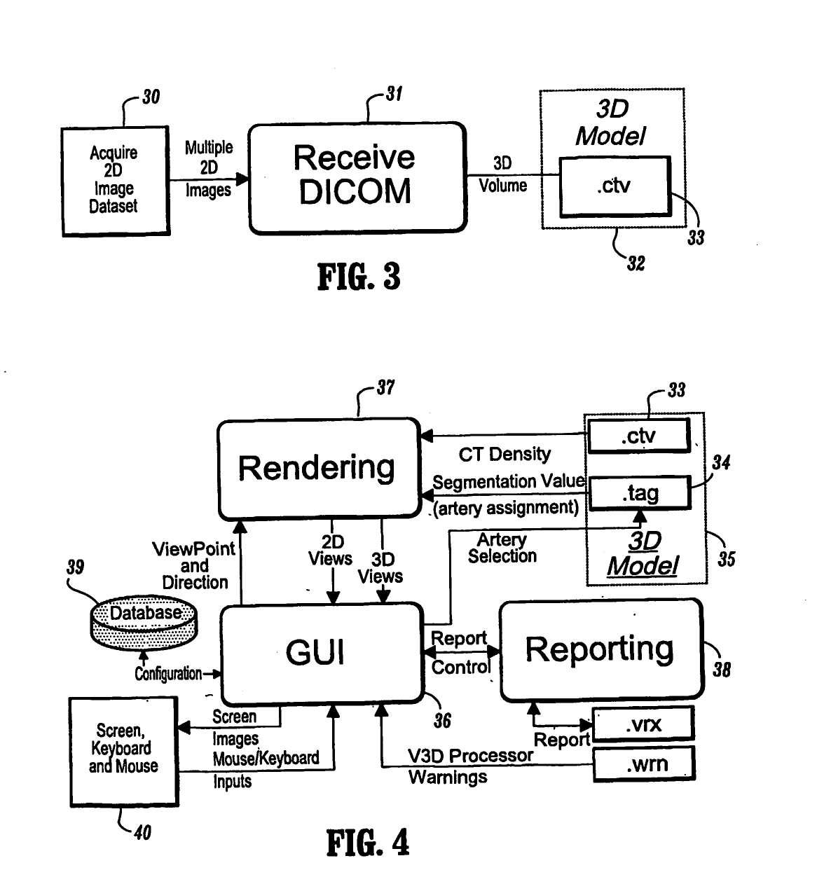

FIG. 3 is a diagram illustrating data processing flow in the calcium scoring system (20) according to one aspect of the invention. A medical imaging device generates a 2D image dataset comprising a plurality of 2D DICOM-formatted images (slices) of a particular anatomical area of interest, e.g., the heart (step 30). The calcium scoring system receives the DICOM-formatted 2D images (step 31) and then generates an initial 3D model (step 32) from a CT volume dataset derived from the 2D slices using known techniques. A .ctv file (33) denotes the original 3D image data is used for constructing a 3D volumetric model, which preferably comprises a 3D array of CT densities stored in a linear array.

FIG. 4 is a diagram illustrating data processing flow in the calcium scoring system (20) of FIG. 2 according to another aspect of the invention. In particular, FIG. 4 illustrates data flow and I/O events between various modules, such as a GUI module (36), Rendering module (37) and Reporting module (38), comprising the calcium scoring module (22) of FIG. 2. Various I/O events are sent between the GUI module (36) and peripheral components (40) such as a computer screen, keyboard and mouse. The GUI module (36) receives input events (mouse clicks, keyboard inputs, etc.) to execute various functions such as interactive manipulation (e.g., artery selection) of a 3D model (35).

The GUI module (36) receives and stores configuration data from database (39). The configuration data comprises meta-data for various patient studies to enable a stored patient study to be reviewed for reference and follow-up evaluation of patient response treatment. The meta-data for a given patient study comprises, e.g., the total number of lesions and for each lesion, meta-data may comprise (i) the seed point in the plaque (the point at which the operator clicked), (ii) the assigned artery (one of LMA, LAD, LC, RCA, or PD), (iii) an Agatston score, (iv) a volume score, and (v) a mass score. The database (39) further comprises initialization parameters (e.g., default or user preferences) such as (i) minimum size of plaques, (ii) maximum size of plaques, (iii) a list of default window-level settings for the Rendering module (37), (iv) the colors of suspicious plaques, noise, bones, arteries, and mean/peak intensities, (v) the preference for coloring plaques by artery, mean intensity, or peak intensity, (vi) the preference for displaying volume in cubic mm or cubic cm, (vii) desired Hounsfield Unit threshold for EBCT scanners, (viii) desired Hounsfield Unit threshold for MSCT scanners, and (ix) desired percentile statistics table to use for comparison.

The rendering module (37) comprises one or more suitable 2D/3D renderer modules for providing different types of image rendering routines. The renderer modules (software components) offer classes for displays of orthographic MPR images and 3D images. The rendering module (37) provides 2D views and 3D views to the GUI module (36) which displays such views as images on a computer screen. The 2D views comprise representations of 2D planer views of the dataset including a transverse view (i.e., a 2D planar view aligned along the Z-axis of the volume (direction that scans are taken)), a sagittal view (i.e., a 2D planar view aligned along the Y-axis of the volume) and a Coronal view (i.e., a 2D planar view aligned along the X-axis of the volume). The 3D views represent 3D views of the dataset.

The rendering module (37) presents 3D views of the 3D model (35) to the GUI module (36) based on the viewpoint and direction parameters (i.e., current viewing geometry used for 3D rendering) received from the GUI module (36). The 3D model (35) comprises the original CT volume dataset (33) and a tag volume (34) which comprising a volumetric dataset comprising a volume of segmentation tags that identify which voxels are assigned to which coronary arteries. Preferably, the tag volume (34) contains an integer value for each voxel that is part of some known (segmented region) as generated by user interaction with a displayed 3D image (all voxels that are unknown are given a value of zero). When rendering an image, the rendering module (37) overlays the original volume dataset (33) with the tag volume (34). The artery selection values and segmentation values comprise enumerated types of the 5 major coronary arteries.

As noted above, the database (39) is used to support various functionality such as user preferences and archival of meta-data. Table 1 below provides a list of variables that are used to support preferences according to a preferred embodiment of the invention.

| | | | 1.1.1.1.1 Value | |
|---|---|---|---|---|
| User ID | Variable Name | Description | Type | Default |
| | MinPlaqueSize | The minimum size of a lesion to be | Volume in cubic | 3 |
| | | considered not noise, but a potential | mm | |
| | | plaque | | |
| | MaxPlaqueSize | The maximum size of a lesion to be | Volume in cubic | 10000 |
| | | considered not bone, but a potential | mm | |
| | | plaque | | |
| | SuspiciousPlaqueColor | The color (RGB 0-255), opacity (0- | string | 255 255 |
| | | 1), and visibility (0 or 1) of | | 0 1.0 1 |
| | | suspicious plaques | | |
| | NoiseColor | The color (RGB 0-255), opacity (0- | string | 255 0 0 |
| | | 1), and visibility (0 or 1) of | | 1.0 1 |
| | | suspected noise | | |
| | BoneColor | The color (RGB 0-255), opacity (0- | string | 255 0 0 |
| | | 1), and visibility (0 or 1) of | | 1.0 0 |
| | | suspected bone | | |
| | LMAArteryColor | The color (RGB 0-255), opacity (0- | string | 255 0 0 |
| | | 1), and visibility (0 or 1) of the LMA | | 1.0 1 |
| | LADArteryColor | The color (RGB 0-255), opacity (0- | string | 0 255 0 |
| | | 1), and visibility (0 or 1) of the LAD | | 1.0 1 |
| | LCArteryColor | The color (RGB 0-255), opacity (0- | string | 0 0 255 |
| | | 1), and visibility (0 or 1) of the LC | | 1.0 1 |
| | RCAArteryColor | The color (RGB 0-255), opacity (0- | string | 255 255 |
| | | 1), and visibility (0 or 1) of the LC | | 0 1.0 1 |
| | PDArteryColor | The color (RGB 0-255), opacity (0- | string | 0 255 |
| | | 1), and visibility (0 or 1) of the PD | | 255 1.0 1 |
| | PlaqueIntensityColor1 | The color (RGB 0-255), opacity (0- | string | 0 0 255 |
| | | 1), and visibility (0 or 1) of the | | 1.0 1 |
| | | lowest intensity plaques | | |
| | PlaqueIntensityColor2 | The color (RGB 0-255), opacity (0- | string | 0 255 0 |
| | | 1), and visibility (0 or 1) of the | | 1.0 1 |
| | | second lowest intensity plaques | | |
| | PlaqueIntensityColor3 | The color (RGB 0-255), opacity (0- | string | 255 255 |
| | | 1), and visibility (0 or 1) of the | | 0 1.0 1 |
| | | second highest intensity plaques | | |
| | PlaqueIntensityColor4 | The color (RGB 0-255), opacity (0- | string | 255 0 0 |
| | | 1), and visibility (0 or 1) of the | | 1.0 1 |
| | | highest intensity plaques | | |
| | ColoringPreference | The method by which to determine | String (one of | artery |
| | | the color of each plaque. Either by | “mean”, “max”, | |
| | | mean intensity, max intensity, or | or “artery” | |
| | | artery assignment | | |
| | VolumeDisplay | Whether to display volume as cubic | String (either | Mm |
| | | mm or cubic cm | “mm” or “cm”) | |
| | EBCTThreshold | The HU above which is considered | floating point | 130 |
| | | calcification in an electron beam CT | | |
| | | scan | | |
| | MSCTThreshold | The HU above which is considered | floating point | 90 |
| | | calcification in a multi-slice CT scan | | |
| | PercentileStatisticsFile | The file path which specifies the | string | TBD |
| | | statistics to use for percentile | | |
| | | ranking | | |

### Graphical User Interfaces—Calcium Scoring Module

The following section describes GUIs for a calcium scoring application according to preferred embodiments of the invention. As noted above, various GUIs (or User Interface (UI) or “interface”) provide a working environment of the calcium scoring module. In general, the GUIs provide access points to menus, buttons, slider bars, checkboxes, views of the electronic model and 2D patient slices of the patient study. Preferably, the user interface is interactive and mouse driven, although keyboard shortcuts are available to the user to issue computer commands. The V3D Explorer's intuitive interface uses a standard computer keyboard and mouse for inputs. The user interface displays orthogonal and multiplanar reformatted (MPR) images, allowing radiologists to work in a familiar environment. Along with these images is a volumetric 3D model of the organ or area of interest. Buttons and menus are used to input commands and selections.

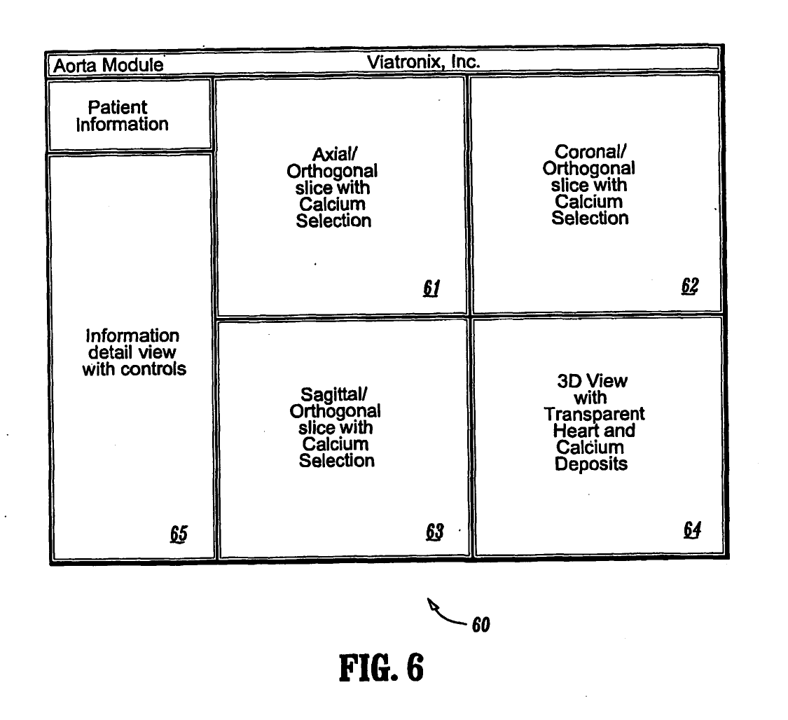

In a preferred embodiment of the invention, the calcium scoring module comprises various interfaces including a general view and a scoring view for performing certain functions. FIG. 6 is an exemplary diagram of a GUI according to an embodiment of the invention, which illustrates a layout of a general visualization view (60) for the calcium scoring module. In a preferred embodiment, the general view (60) is a primary view which preferably appears upon launching a calcium scoring application according to the invention. The calcium scoring general default interface (60) preferably displays an image area comprising four image frames (or “views”) (61, 62, 63, 64) for displaying three 2D orthogonal, multiplanar reformatted (MPR) images and a 3D translucent heart view with calcium areas depicted by color. More specifically, the image area of the general view (60) comprises a view (61) for displaying axial oriented slices, a view (62) for displaying coronal oriented slices, a view (63) for displaying sagittal oriented slices, and a view (64) for displaying a rotatable 3D virtual model of the heart.

The 2D views (61, 62, 63) allow a user to scroll through the corresponding MPR slices (using e.g., mouse wheel), which enables the user to determine orientation, contextual information and easy selection of calcified regions.

The 3D view (64) displays an external 3D images of the heart, providing a translucent view of coronary arteries, which can be rotated by the user. The 3D view (64) preferably provides a translucent view of the heart and coronary arteries with the thresholded voxels colored as in the 2D slices. Further, the various views are correlated. For instance, the 3D view preferably provides marker to indicate the current position of the 2D slices (either colored shadows or planes) so that the user can mentally correlate similar locations in the various views.

Preferably, the 3D view provides a translucent view of the heart and coronary arteries with the thresholded voxels colored as in the 2D slices, provide a translucent view of the heart and coronary arteries with the selected calcium regions colored as in the 2D slices, provide markers to indicate the current position of the 2D slice (either via colored shadows or planes). The 3D image comprises anatomical positional markers show where the current 2D view is located, and calcified plaque areas are shown in the same color code as the in the 2D slices.

The general view (60) further comprises an information area (65) which preferably presents a plurality of information panes comprising, for example, a Layouts pane, a Study Information pane, a Scores pane, a Plaques pane, an Annotations pane, and a Visualization Settings pane. In one preferred embodiment, the Layouts pane comprises a plurality of buttons that allows the user to select between various user interfaces.

When selected, the Study Information pane displays data such as patient information (e.g. patient name, date of birth), study information (e.g. study date, study location, scanning protocol), and evaluation information (e.g. evaluation date and time, evaluation location, name of the person performing evaluation), and other informative data such as scan date, scanner spacing, thickness, contrast level etc.

The Scores pane comprises a score table that lists scores such as Agatston and Volume scores and plaque counts for various arteries. In other words, the scores table keeps track of the plaques by location, listing the count (i.e., the number of lesions at that location) and corresponding scores for the locations. For example, the LMA artery location lists five separate plaque sites for that location, and the LC artery shows three plaque sites.

The Plaques pane lists each user selected plaque site by number, including plaques with multiple locations as separate items, and the total plaque score for that numbered item. As the user identifies and scores each plaque, the calcium scoring module numbers the lesion and records the Agatston and Volume scores by artery (LMA, RCA, etc.).

As noted above, the calcium scoring module can automatically tag (colorize) voxels above a certain threshold density for easy identification of potential plaque areas in the coronary arteries. The color-codes use thresholded voxels for identification, and the Visualization Settings pane can be used to control how the interface displays these areas in the scoring interface before they are selected. The user can adjust these settings to his/her preferences.

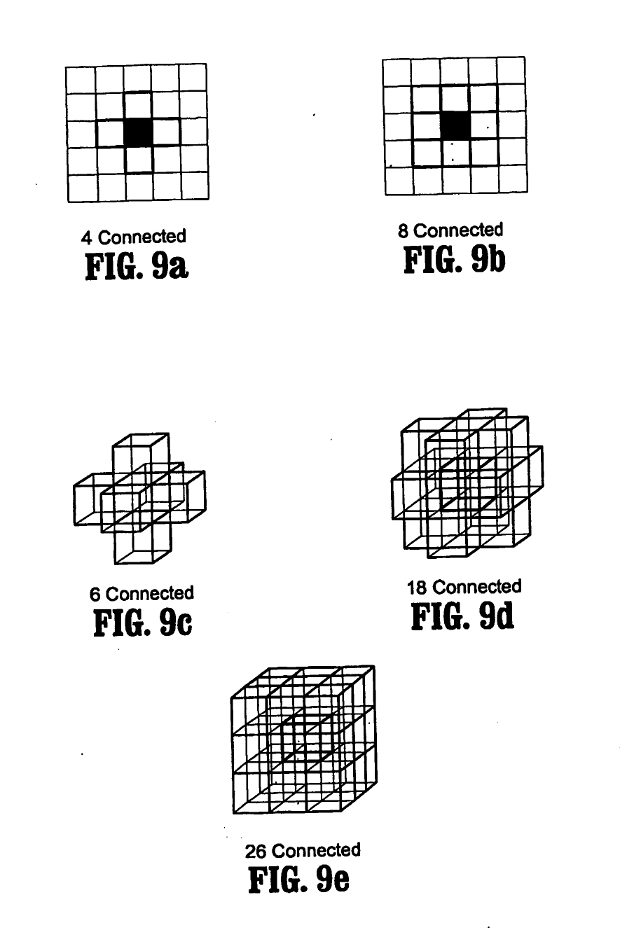

As noted above, the general user interface (60) allows the user to display 2D and 3D cardiac images showing calcified plaque regions. One advantageous function provided by a calcium scoring tool according to the invention is the automatic separation of noise, bones, and potential plaques based on preset (default) user-specified volume thresholds or area thresholds, as well as user-selected volume thresholds or area thresholds, which are selected during a evaluation session. A connected component is a region of neighboring voxels that all share the same property. To find plaques in a CT scan, connected components that are within a certain intensity range are determined. If the connected component comprises only two or three voxels, than it is safe to assume that connected component is not a plaque, but rather noise in the data. If the size of the connected component corresponds to a volume of 3×3×3 cubic mm, then the connected component may be a plaque. If the size of the connected component, corresponds to a volume larger than 10×10×10 cubic cm, than the connected component is probably bone. There are gray zones in between these obvious choices and each doctor has his/her own opinion as to what size range is needed to exclude features from the potential plaque range. Therefore, a system according to the invention allows the doctor to set his/her own range preferences, which are then automatically used by the system. The size preference may be specified based on number of pixels within a 2D axial plane, based on the number of voxels in the 3D scan, or based on the corresponding real world area in square mm on a plane or volume in cubic mm in 3D space. Further, the preferences for determining neighboring voxels can be based on the known region growing methods depicted in FIGS. 9(a)-(e). For instance, as shown in FIGS. 9(a) and 9(b), for 2D images, connectivity selection can be based on a 4 connected or 8 connected 2D-neighborhood. Further, as shown in FIGS. 29(c), (d) and (e), connectivity can be based on a 6 connected, 18 connected or 26 connected 3D neighborhood.

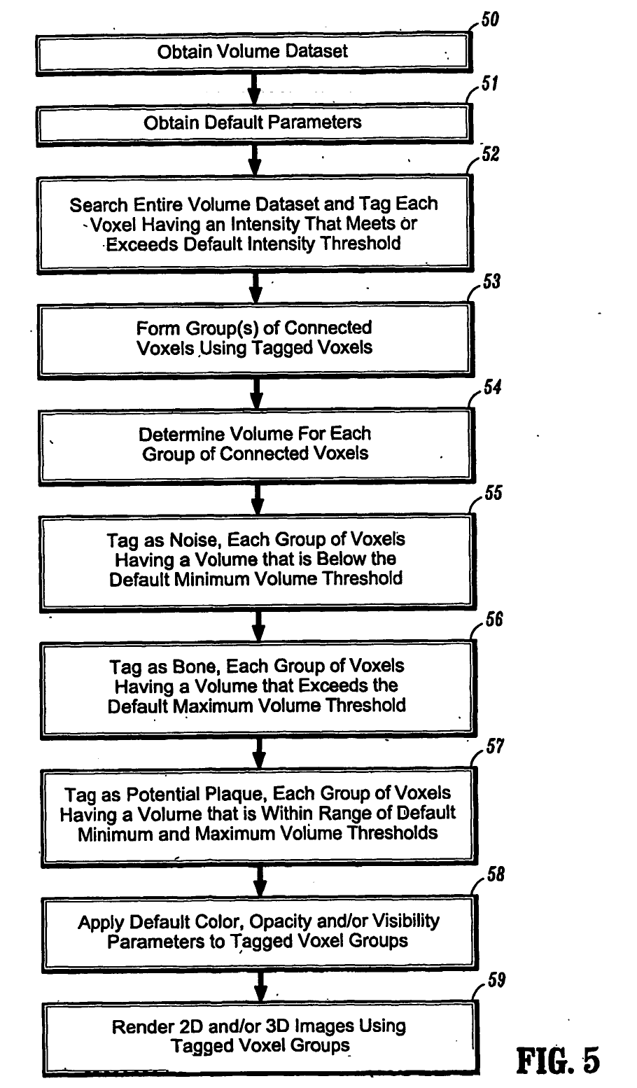

By way of example, FIG. 5 is a flow diagram illustrating a method for providing automatic separation of noise, bones and potential plaques based on user specified volume and area thresholds according to one aspect of the invention. Initially, upon launching a session, a dataset will be loaded (step 50). The database is accessed to obtain default parameters (preset user preferences) (step 51) that are used for automatically determining potential plaque sites and separating out bones and noise before rendering and displaying. For example, such default parameters include an intensity (HU) threshold (e.g., 130), minimum and maximum volume thresholds or area thresholds for plaque, as well as color, opacity and visibility parameters for noise, bone and potential plaques, etc.

The volume dataset is searched and each voxel having an intensity value that meets or exceeds the default intensity threshold is tagged (step 52). Then, groups of connected voxels are formed using the tagged voxels (step 53). This step enables potential lesions to be defined by connected components of voxels that share a density value above a given intensity threshold.

Then, a volume is determined for each group of connected voxels (step 54). If a given volume for a group of connected voxels is below the default minimum volume (or area if used) threshold, the group is tagged as noise (step 55). Indeed, if the volume of the voxel group is small, it is presumed to be so small as to be simply noise. If the volume for a given group of connected voxels is above the default maximum volume (or area if used) threshold, the group is tagged as bone (step 56). Indeed, if the volume for the group is large, the group is presumed to be bone or some other unnaturally large region. If a volume for a given group of connected voxels falls within the range of default minimum and maximum thresholds, the group is tagged as potential plaque (step 57).

Once all groups of voxels have been classified, the default color, opacity and/or visibility parameters will be applied to the tagged voxel groups (step 58) and the 2D and/or 3D images will be rendered accordingly (step 59). For instance, the default parameters may be set such that the bone and noise are not displayed at all (invisible) and only the potential plaque sites are display. In addition, the parameters may be set such that the potential plaque regions are colored and the other components in the image are translucent. This simplifies the task of finding actual lesions.

It is to be appreciated that the invention provides improvements to regular volume or surface rendered 3D view of the heart by embedding within the image potential and/or selected plaques using a combination of high-intensity color and high opacity. By opacifying the plaques more than the average heart structure, the visual embedding of plaques can be achieved. The heart structures can be reduced in opacity until the effect of a semi-translucent heart is achieved through which the plaques can be seen. By rotating such a display, the location and extent of plaques can be better visualized.

The flow diagram of FIG. 5 illustrates a method wherein the automatic selection process occurs without user intervention at load time by accessing default parameters. It is to be understood, however, that the above process equally applies when the user selects new parameters during a session and re-renders the images using the new parameters to automatically separate out unwanted components from the image.

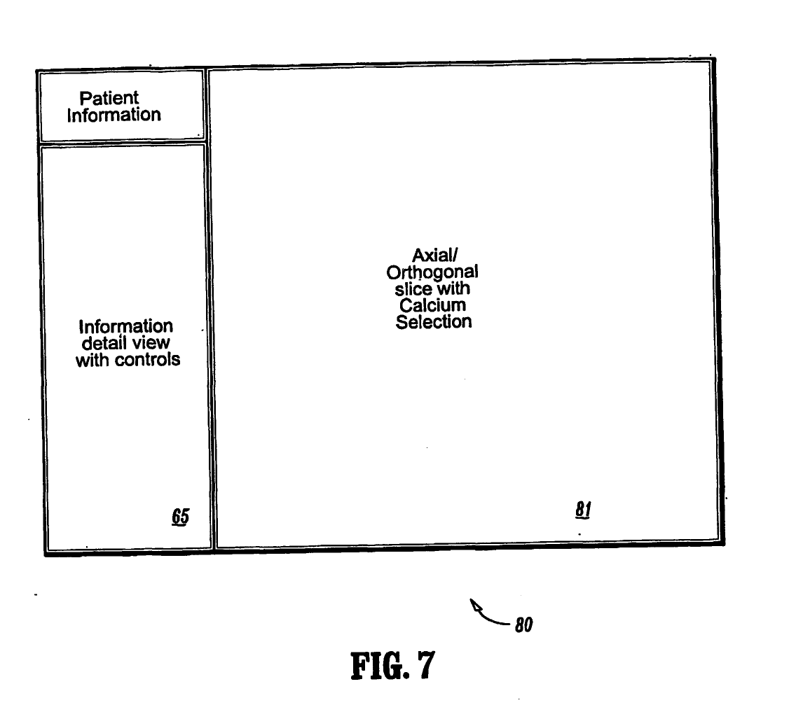

FIG. 7 is an exemplary diagram of a GUI according to an embodiment of the invention, which illustrates a scoring interface (80) for enabling calcium scoring. The scoring interface (80) is similar to the general interface (60), but the scoring interface (80) preferably comprises an image area (81) that displays a close-up of the 2D Axial image, and provides functionality to enable the user to quantify/measure the amount of calcium found in coronary arteries (i.e., calcium scoring). In the scoring interface (80), the user can scroll through the 2D slice image-set by placing the mouse pointer on the image and using the mouse wheel to view one image at a time to find and measure plaque sites.

In general, the scoring interface (80) provides functionality that allows a user to (i) scroll the MPR slices, (ii) automatically mark (in color) the voxels above a set threshold density (e.g., voxels>threshold HU) (default values are stored in the configuration file, and the user can modify threshold values within defined range), and (iii) select areas of calcium and assign them to a specific cardiac artery by selecting from a list of arteries (e.g., allow selection of marked voxels, assign entire connected region to calcium score by automatic 3D growing, allow manual assignment of the connected region to a specific artery, and allow manual modification of the assignment of the region to a different artery). Further, the scoring interface (80) comprises functions that enable a user to track the number of lesions selected for each artery and determine the cumulative number of lesions for all arteries.

In addition the Scoring View (80) provides methods to compute calcium scores of the cardiac arteries (e.g., Agatston Score, Volume Score, Mass score) of the calcium in each of the 5 major coronary arteries (by assignment, then visualization with different colors). In addition, the scoring interface (80) enables user to determine the cumulative volumetric score for all arteries, the cumulative Agatston Score for all arteries, and the cumulative mass score for all arteries. Moreover, the scoring interface (80) allows a user to modify the window/level and set the minimum size of the plaques displayed in the image area of the scoring interface Scoring View (80).

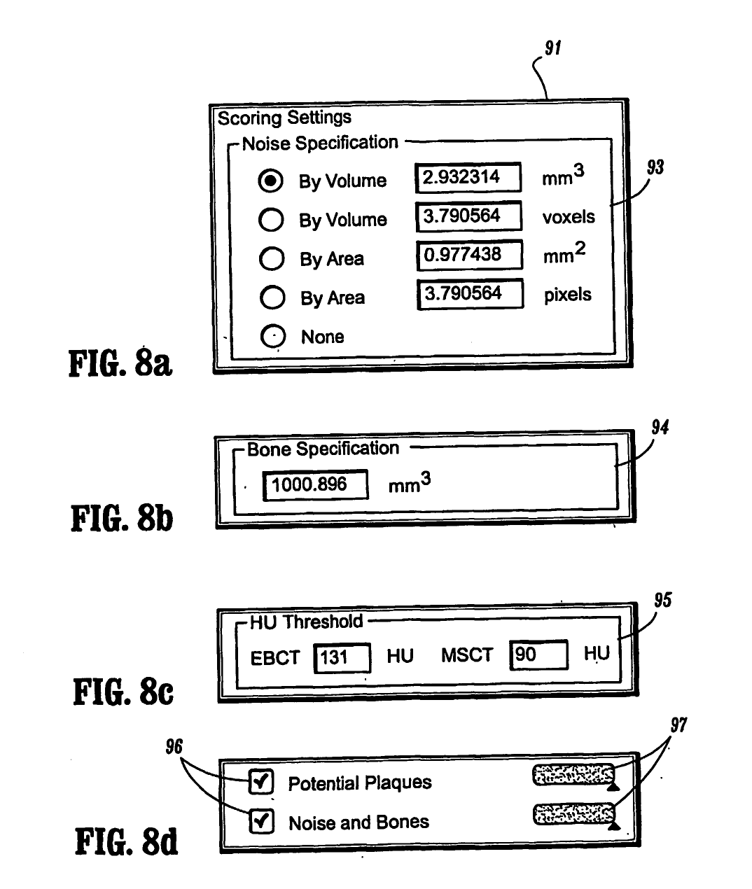

FIGS. 8(a)-8(d) are exemplary diagrams of graphic frameworks for a customize preferences window according to an embodiment of the invention, which provide an interface for the user to set user preferences for visualization. As shown in FIG. 8a, a Scores Setting area (91) comprise an area for setting noise specifications (93), wherein the user can set noise specification parameters (93) in either volume (cubic millimeter (mm³) or in Voxels) or in area (squared millimeter (mm²) or Pixels). The Score Settings area (91) further comprises areas for selecting bone specifications (94) and HU threshold (95). The Bone specification (94) allows the user to set a default value in cubic millimeters. Further, in FIG. 8d, the buttons (96) allow a user to display selected plaque sites in the images using preferred colors, which are selected via color bars (97).

Another advantageous function provided by a calcium scoring application according to the invention is the display of (MIP or shaded) plaques and suspected plaques that appear to be floating on top of a shaded heart. The heart tissue can possibly obscure plaques embedded within the heart. To avoid this, the plaques can be volume (or MIP) rendered into a separate buffer and the image of the plaques can be superimposed over the volume (or MIP) rendered images as a post-process. Another way to perform this is within a single rendering pass in which certain materials (e.g., plaques) reflect light of a different wavelength (e.g., x-ray) that is not attenuated by visible light. By doing this, the size and existence of the plaques can be better visualized.

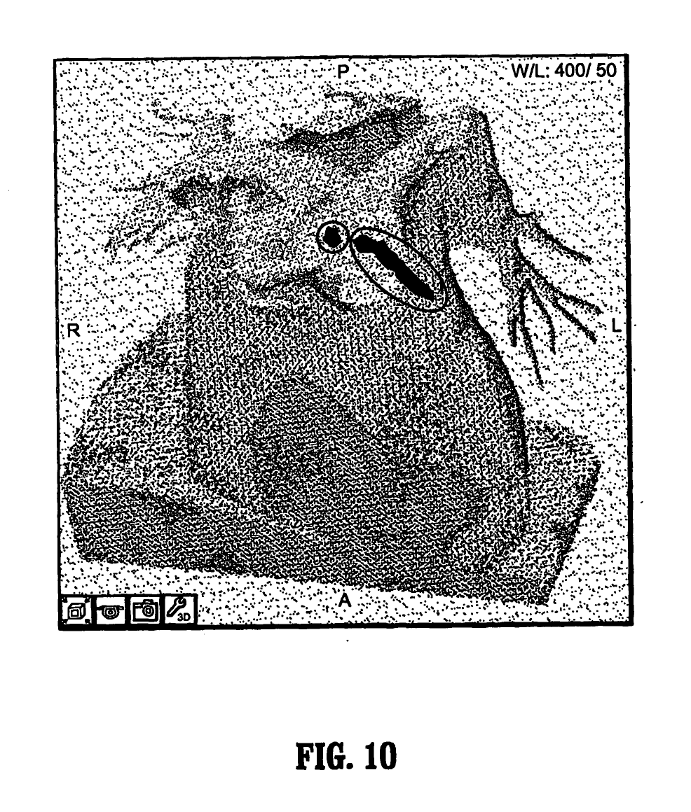

For example, FIG. 10 illustrates a 3-dimensional image where plaque sites (circled areas) appear to be floating on top of the image, and include the image data from all 2-d slices associated with the plaque. The rendering may be performed using known methods such as ray-casting and/or texture mapping using compositing and/or maximum intensity projection and/or minimum intensity projection and/or summation.

Although illustrative embodiments have been described herein with reference to the accompanying drawings, it is to be understood that the invention described herein is not limited to those precise embodiments, and that various other changes and modifications may be affected therein by one skilled in the art without departing from the scope or spirit of the invention. For instance, one of ordinary skill in the art can readily envision the application of the methods discussed herein for analyzing other anatomical components (e.g., nodules in lungs, plaque formation in the vascular system, etc.) All such changes and modifications are intended to be included within the scope of the invention as defined by the appended claims.

What is claimed is:

1. A method for displaying medical images, comprising the steps of
obtaining an image dataset comprising anatomical image data;
automatically grouping connected components in the image data to form groups of connected components; and
displaying an image such that the groups of connected components are distinguishable in the displayed image.

2. The method of claim 1, wherein the image dataset comprise a volume data set and wherein the groups of connected components comprise regions of neighboring voxels that share a similar property.

3. The method of claim 1, wherein the image dataset comprises a 2-dimensional data set and wherein the groups of connected components comprise regions of neighboring pixels that share a similar property.

4. The method of claim 1, wherein the step of displaying comprises displaying different groups of connected components in different colors.

5. The method of claim 1, wherein the step of displaying comprises displaying different groups of connected components with different opacities.

6. The method of claim 1, wherein the step of displaying comprises displaying the image such that groups of connected components are not visible in the displayed image.

7. The method of claim 1, wherein the image dataset comprises voxels and wherein the step of automatically grouping connected components comprises the steps of:
tagging each voxel having an image intensity that exceeds a default image intensity threshold;
forming groups of neighboring voxels that share a same property, using the tagged voxels; and
classifying a group of voxels based on a volume of the group or the number of voxels in the group.

8. The method of claim 7, wherein the step of classifying comprises labeling each group of voxels as one of noise, potential plaque and bone.

9. The method of claim 8, wherein a group of voxels is labeled as noise if the volume falls below a default minimum volume threshold or if the number of voxels falls below a default minimum number threshold or if the area falls below a default minimum area threshold or if the number of pixels in a slice falls below a default minimum number threshold.

10. The method of claim 8, wherein a group of voxels is labeled as plaque if the volume falls within a range of a default minimum volume threshold and a default maximum volume threshold, or if the number of voxels falls within a range of a default minimum number threshold and a default maximum number threshold.

11. The method of claim 8, wherein a group of voxels is labeled as bone if the volume exceeds a default maximum volume threshold or if the number of voxels exceeds a default maximum number threshold.

12. The method of claim 8, wherein the step of displaying comprises the steps of using window/level grayscale coloring for voxels that are identified as noise, bone or both.

13. A program storage device readable by machine, tangibly embodying a program of instructions executable by the machine to perform method steps for displaying medical images, comprising the steps of:
obtaining an image dataset comprising anatomical image data;
automatically grouping connected components in the image data to form groups of connected components; and
displaying an image such that the groups of connected components are distinguishable in the displayed image.

14. The program storage device of claim 13, wherein the image dataset comprise a volume data set and wherein the groups of connected components comprise regions of neighboring voxels that share a similar property.

15. The program storage device of claim 13, wherein the image dataset comprises a 2-dimensional data set and wherein the groups of connected components comprise regions of neighboring pixels that share a similar property.

16. The program storage device of claim 13, wherein the instructions for performing the step of displaying comprise instructions for displaying different groups of connected components in different colors.

17. The program storage device of claim 13, wherein the instructions for performing the step of displaying comprise instructions for displaying different groups of connected components with different opacities.

18. The program storage device of claim 13, wherein the instructions for performing the step of displaying comprise instructions for displaying the image such that groups of connected components are not visible in the displayed image.

19. The program storage device of claim 13, wherein the image dataset comprises voxels and wherein the instructions for performing the step of automatically grouping connected components comprise instructions for performing the steps of
tagging each voxel having an image intensity that exceeds a default image intensity threshold;
forming groups of neighboring voxels that share a same property, using the tagged voxels; and
classifying a group of voxels based on a volume of the group or the number of voxels in the group.

20. The program storage device of claim 19, wherein the instructions for performing the step of classifying comprise instructions for labeling each group of voxels as one of noise, plaque and bone.

21. The program storage device of claim 20, wherein a group of voxels is labeled as noise if the volume falls below a default minimum volume threshold or if the number of voxels falls below a default minimum number threshold or if the area falls below a default minimum area threshold or if the number of pixels in a slice falls below a default minimum number threshold.

22. The program storage device of claim 20, wherein a group of voxels is labeled as plaque if the volume falls within a range of a default minimum volume threshold and a default maximum volume threshold, or if the number of voxels falls within a range of a default minimum number threshold and a default maximum number threshold.

23. The program storage device of claim 20, wherein a group of voxels is labeled as bone if the volume exceeds a default maximum volume threshold or if the number of voxels exceeds a default maximum number threshold.

24. The program storage device of claim 20, wherein the step of displaying comprises the steps of using window/level grayscale coloring for voxels that are identified as noise, bone or both.

25. A method for displaying medical images, comprising the steps of:
obtaining an image dataset comprising anatomical image data;
volume rendering the image data;
rendering a subset of the image data; and
displaying an image of the volume rendered image data and rendered subset such that a view of the data in the subset is not obscured by remaining image data in the view.

26. The method of claim 25, wherein the step of displaying comprises displaying a 3-dimensional image of the anatomical image data or displaying a 2-dimensional slice of the anatomical image data.

27. The method of claim 25, wherein the image data comprises a CT (computed tomography) dataset of a heart and wherein the subset of the data comprises plaque.

28. The method of claim 25, wherein the step of rendering the image data and subset data is based ray-casting or texture mapping or both, using composition, MIP (maximum intensity projection), minimum intensity projection, summation or any combination thereof.
